(19) United States
(12) Patent Application Publication
(10) Pub. No.: US 2007/0082778 A1
(43) Pub. Date: Apr. 12, 2007

(54) Automatic transmission

(75) Inventors: Norihiro Yamamura, Nishikamo-gun (JP); Yuji Yasuda, Nishikamo-gun (JP); Hirofumi Onishi, Aichi-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/541,738

(22) Filed: Oct. 3, 2006

(30) Foreign Application Priority Data
Oct. 7, 2005 (JP) 2005-295211

(51) Int. Cl. F16H 3/44

(52) U.S. Cl. 475/317

(57) ABSTRACT

A drive unit qualified as an automatic transmission- includes a rotational shaft transmitting power, a planetary gear mechanism linked to the rotational shaft, and a friction engagement device provided at the outer circumferential side of the planetary gear mechanism. The planetary gear mechanism includes a pinion gear, and a pinion shaft supporting the pinion gear in a rotatable manner. The pinion shaft includes an oil inlet through which oil flows in, an oil outlet provided so as to supply oil flowing in from the oil inlet to the friction engagement device, and an oil channel communicating the oil inlet with the oil outlet.

This nonprovisional application is based on Japanese Patent Application No. 2005-295211 filed with the Japan Patent Office on Oct. 7, 2005, the entire contents of which are hereby incorporated by reference.

### BACKGROUND OF THE INVENTION

1. Field of the Invention

The present invention relates to automatic transmissions, particularly an automatic transmission including a friction engagement device.

2. Description of the Background Art

An automatic transmission including a friction engagement device is conventionally known.

For example, Japanese Patent Laying-Open No. 8-277909 (Patent Document 1) discloses an automatic transmission that includes a planetary gear device, and a clutch and brake constituting a friction engagement device. The planetary gear device and friction engagement device are arranged within a transmission case. The oil in the transmission case is supplied to each element including the planetary gear device and friction engagement device for lubrication and cooling thereof

Japanese Patent Laying-Open No. 2000-2318 (Patent Document 2) discloses a plug with an orifice.

The automatic transmission of Patent Document 1 has an oil channel provided at the pinion shaft. Patent Document 1 is silent about the oil flowing out from the oil channel being supplied to the friction engagement device. Further, Patent Document 1 does not explicitly show the path of oil supplied to the friction engagement device. The amount of oil supplied to the friction engagement device may not necessarily be sufficient depending upon the path of oil supplied to the friction engagement device.

Patent Document 2 similarly does not disclose a configuration to overcome the problem set forth above.

### SUMMARY OF THE INVENTION

An object of the present invention is to provide an automatic transmission having oil supply to a friction engagement device facilitated.

An automatic transmission according to the present invention includes a rotational shaft transmitting power, a planetary gear mechanism linked to the rotational shaft, and a friction engagement device provided at the outer circumferential side of the planetary gear mechanism. The planetary gear mechanism includes a pinion gear, and a pinion shaft supporting the pinion gear in a rotatable manner. The pinion shaft includes an oil inlet through which oil is input, an oil outlet provided so as to supply the oil flowing in from the oil inlet to the friction engagement device, and an oil channel communicating the oil inlet with the oil outlet.

Since oil can be supplied to the friction engagement device via the pinion shaft in accordance with the configuration set forth above, supply of oil to the friction engagement device is facilitated.

Preferably, the automatic transmission further includes a plug including an orifice to adjust the amount of oil flowing out from the oil outlet.

Accordingly, the amount of oil flowing out from the oil outlet can be adjusted.

In the automatic transmission set forth above, the oil in the channel is preferably supplied to the oil outlet and the bearing between the pinion shaft and pinion gear.

In accordance with the present configuration, the aforementioned oil channel can be used in common as a path of oil for the friction engagement device and a path of oil for the bearing. Therefore, the number of holes provided at the component of the automatic transmission to form an oil channel can be reduced. As a result, supply of oil to the friction engagement device can be facilitated without excessively reducing the rigidity of the component of the automatic transmission.

In the automatic transmission set forth above, the oil outlet is preferably provided at an axial end face of the pinion shaft.

Preferably, the automatic transmission further includes a member provided so as to extend from above the oil outlet to a friction member of the friction engagement device.

By virtue of the above-described configuration, oil flowing out from the oil outlet is guided towards the friction engagement device along the member extending from above the oil outlet to the friction member to facilitate oil supply. Therefore, supply of oil to the friction engagement device is further facilitated.

The aforementioned “automatic transmission” includes any of a power transmission device of a hybrid vehicle having a transmission and a drive shaft integrally formed, or a device including only a transmission.

In accordance with the present invention, supply of oil to the friction engagement device can be facilitated in the automatic transmission set forth above.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view of an automatic transmission according to an embodiment of the present invention.

FIG. 2 is a diagram to describe the force acting on oil located on the inner circumferential face of the ring gear.

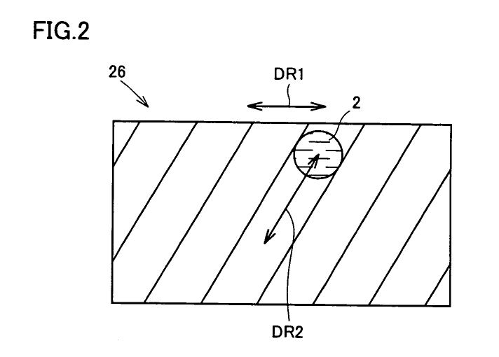

### DESCRIPTION OF THE PREFERRED EMBODIMENTS

An embodiment of an automatic transmission according to the present invention will be described hereinafter. Similar or corresponding components have the same reference characters allotted, and description thereof may not be repeated.

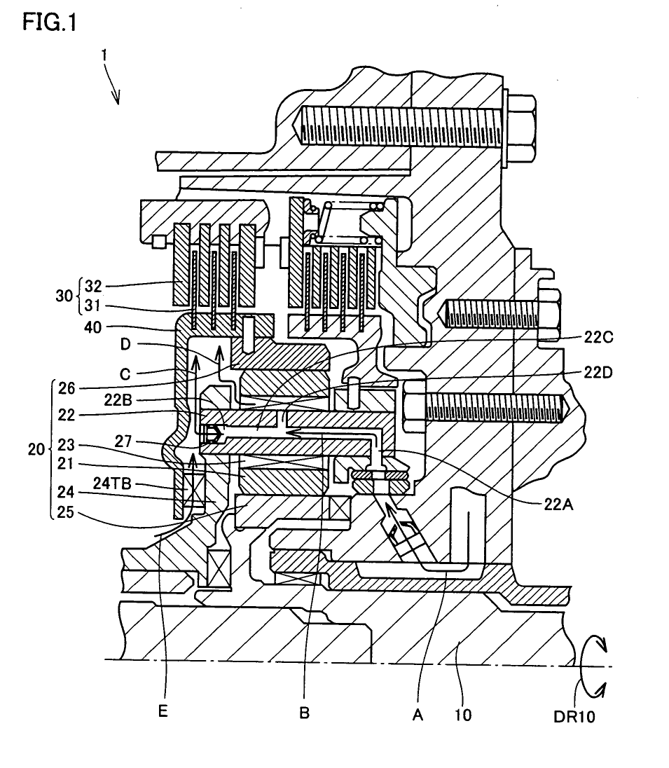

FIG. 1 is a sectional view of an automatic transmission according to an embodiment of the present invention. Referring to FIG. 1, an automatic transmission 1 of the present embodiment includes a rotational shaft 10 transmitting power, a planetary gear mechanism 20 linked to rotational shaft 10, and a friction engagement device 30 provided at the outer circumferential side of planetary gear mechanism 20.

Rotational shaft 10 is a rotary element rotating in the direction of arrow DR10. Planetary gear mechanism 20 includes a pinion gear 21, a pinion shaft 22 supporting pinion gear 21 in a rotatable manner via a bearing 23, a planetary carrier 24 that holds pinion shaft 22, a sun gear 25 rotating together with rotational shaft 10, and a ring gear 26.

Friction engagement device 30 includes friction members 31 and 32. Torque is transmitted between friction members 31 and 32 by friction as a result of friction members 31 and 32 urged against each other. Accordingly, a clutch mechanism connecting/disconnecting a planetary carrier with/from a ring gear of the plurality of planetary gears, and a brake mechanism locking the planetary carrier are implemented.

In the embodiment of FIG. 1, friction member 31 is attached to a hub 40 that rotates together with ring gear 26. A thrust bearing 24TB is provided between hub 40 and planetary carrier 24.

Oil circulates in the casing of automatic transmission 1. The circulating oil in the casing lubricates and cools each component of automatic transmission 1.

Pinion shaft 22 includes an oil inlet 22A through which oil flows in, an oil outlet 22B from which oil input through oil inlet 22A flows out, and an oil channel 22C communicating oil inlet 22A with oil outlet 22B.

Oil inlet 22A is provided at the cylindrical face of pinion shaft 22. Oil outlet 22B is provided at the axial end face of pinion shaft 22. Oil channel 22C is provided to extend in the axial direction of pinion shaft 22. In the embodiment of FIG. 1, oil channel 22C is formed on the axial core of pinion shaft 22. Alternatively, oil channel 22C may be formed deviated from the axial core of pinion shaft 22.

Oil flows into oil inlet 22A from the direction of arrow A. The oil flowing to pinion shaft 22 flows through oil channel 22C in the direction of arrow B. The oil flowing through oil channel 22C flows out from oil outlet 22B in the direction of arrow C. Accordingly, oil is supplied to friction engagement device 30. In other words, oil outlet 22B is provided so as to supply oil flowing in through oil inlet 22A to friction engagement device 30.

The oil flowing through oil channel 22C flows out from oil outlet 22B to be supplied to bearing 23 located between pinion shaft 22 and pinion gear 21 via an oil channel 22D provided at pinion shaft 22. Oil channel 22D extends radially in pinion shaft 22. Accordingly, oil channel 22C can be used in common as the oil path for friction engagement device 30 and the oil path for bearing 23. Therefore, the number of holes provided at the component of automatic transmission 1 can be reduced. As a result, oil supply to friction engagement device 30 can be facilitated without excessively degrading the rigidity of the component of automatic transmission 1. At oil outlet 22B is provided a plug 27 including an orifice to adjust the amount of oil flowing out from oil outlet 22B. Accordingly, the balance between the amount of oil supplied to bearing 23 and the amount of oil flowing out from oil outlet 22B can be adjusted. The location of plug 27 is not limited to that in oil outlet 22B, and may be provided at oil channel 22C slightly upstream of oil outlet 22B.

Hub 40 identified as a “member” is provided to extend from above oil outlet 22B to friction member 31 of friction engagement device 30. Accordingly, the oil flowing out from oil outlet 22B is directed to friction engagement device 30 along hub 40, facilitating oil supply to friction engagement device 30.

Possible oil paths to friction engagement device 30 other than the path through oil channel 22C (arrows A, B and C) may include, for example, a path (arrow D) through bearing 23 and a side washer (not shown), and a path (arrow E) through thrust bearing 24TB. However, the amount of oil flowing leftwards in the drawing as indicated by arrow D among the oil supplied to bearing 23 may not necessarily be sufficient for the amount of oil to be supplied to friction engagement device 30. Similarly, the amount of oil flowing through thrust bearing 24TB as indicated by arrow E may not necessarily be sufficient for the amount of oil to be supplied to friction engagement device 30. When a helical gear is used for ring gear 26, force acts on the oil on the inner circumferential face of ring gear 26 in the direction along the helical teeth (twisting direction) in association with the rotation of ring gear 26. As a result, there is a case where the amount of oil supplied to friction engagement device 30 via bearing 23 is influenced by the direction of rotation (direction of arrow DR1) of ring gear 26 and the twisting direction (direction of arrow DR2) of ring gear 26.

By providing oil inlet 22A, oil outlet 22B and oil channel 22C as set forth above in automatic transmission 1 of the present embodiment, oil can be supplied to friction engagement device 30 via pinion shaft 22. Thus, oil supply to friction engagement device 30 can be facilitated. Since oil outlet 22B faces the space surrounded by hub 40, planetary carrier 24, thrust bearing 24TB, ring gear 26, and the like, the oil flowing out from oil outlet 22B is effectively guided to friction engagement device 30.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An automatic transmission comprising:
a rotational shaft transmitting power,
a planetary gear mechanism linked to said rotational shaft, and
a friction engagement device provided at an outer circumferential side of said planetary gear mechanism,
wherein said planetary gear mechanism comprises
a pinion gear, and
a pinion shaft supporting said pinion gear in a rotatable manner,
wherein said pinion shaft includes
an oil inlet through which oil flows in,
an oil outlet provided so as to supply oil flowing in from said oil inlet to said friction engagement device, and
an oil channel communicating said oil inlet with said oil outlet.

2. The automatic transmission according to claim 1, further comprising a plug including an orifice to adjust an amount of oil flowing from out said oil outlet.

3. The automatic transmission according to claim 1, wherein oil in said oil channel is supplied to said oil outlet and a bearing located between said pinion shaft and said pinion gear.

4. An automatic transmission according to claim 1, further comprising a member provided so as to extend from above said oil outlet to a friction member of said friction engagement device.
